(19) United States
(12) Patent Application Publication
(10) Pub. No.: US 2019/0024832 A1
(43) Pub. Date: Jan. 24, 2019

(54) PIPING

(71) Applicants: DENSO CORPORATION, Kariya-city, Aichi-pref. (JP); DENSO AIR SYSTEMS CORPORATION, Anjo-shi, Aichi-pref. (JP)

(72) Inventors: Shinji SUGISHITA, Kariya-city (JP); Tatsuhito MATSUMOTO, Anjo-city (JP); Masakazu KONDO, Anjo-city (JP)

(21) Appl. No.: 16/072,942

(22) PCT Filed: Jan. 12, 2017
(86) PCT No.: PCT/JP2017/000783

§ 371 Date: Jul. 26, 2018

(30) Foreign Application Priority Data
Jan. 28, 2016 (JP) 2016-014433

(51) Int. Cl. F16L 33/207; F16L 11/04

(52) U.S. Cl. CPC F16L 33/2076; F16L 2011/047; F16L 11/045

(57) ABSTRACT

A piping includes: a hose made of an elastic material; a pipe made of metal, the pipe having an insertion part inserted inside of the hose; and a sleeve arranged on an outer side of the insertion part and the hose in a radial direction. The insertion part has an uneven surface around an outer circumference side of the insertion part, and the uneven surface has an annular groove and an annular projection. The groove has a groove slope that narrows the pipe toward a tip end of the insertion part, and a groove bottom that extends from an insertion-tip-side end of the groove slope to the projection with a constant outer diameter. The sleeve has a small diameter part located on an outer side of the uneven surface in the radial direction to press the hose against the uneven surface.

### CROSS REFERENCE TO RELATED APPLICATION

This application is based on Japanese Patent Application No. 2016-14433 filed on Jan. 28, 2016, the disclosure of which is incorporated herein by reference.

### TECHNICAL FIELD

The present disclosure relates to a piping that connects a hose made of elastic material, and a pipe made of metal.

### BACKGROUND ART

Conventionally, such a kind of piping is described, for example, in Patent Literature 1. The piping described in Patent Literature 1 includes a hose made of elastic material, a pipe made of metal, and a sleeve made of metal. The pipe has an insertion part inserted inside of the hose from an end of the hose. The sleeve is arranged on the radially outer side of the insertion part and the hose, and presses the hose against the insertion part.

An uneven surface is formed on the outer circumference side of the insertion part, and has an annular groove and an annular projection. Moreover, the uneven surface has a sealing surface formed in a boundary part between an insertion-tip-side end of the groove and the projection, and a slope surface which narrows the pipe as extending toward the tip side end of the insertion part. The groove is defined by the slope surface and the sealing surface.

The hose is forced onto the uneven surface by the sleeve, thereby the inner circumference part of the hose is bitten by the groove, so as to be forced onto the sealing surface. Moreover, a tension is applied to the hose by a pressure of fluid in the piping, in a direction that the hose escapes from the sleeve. Due to the tension applied to the hose, a required bearing pressure is secured at a contact part at which the inner circumference part of the hose and the sealing surface are in contact with each other. Accordingly, the sealing nature is given between the hose and the insertion part.

### PRIOR ART LITERATURES

### Patent Literature

### Patent Literature 1: JP 5556624 B2

### SUMMARY OF INVENTION

However, in the conventional piping configuration in which the groove is defined by the slope surface and the sealing surface, a space available for the hose to be bitten by the groove is small. If the bite amount of the hose decreases, the contact area for connecting the hose and the sealing surface decreases.

Moreover, if the hose is moved by the above-described tension applied to the hose in a direction escaping from the sleeve, the contact area for connecting the hose and the sealing surface further decreases. In this case, the sealing nature is lowered at a portion of the contact area especially where the engagement between the hose and the sealing surface is decreased.

It is an object of the present disclosure to provide a piping in which the sealing nature is raised between a hose made of elastic material and a pipe made of metal.

According to an aspect of the present disclosure, a piping includes: a hose made of an elastic material; a pipe made of metal, the pipe having an insertion part inserted inside of the hose from an end of the hose; and a sleeve arranged on an outer side of the insertion part and the hose in a radial direction to press the hose against the insertion part. The insertion part has an uneven surface around an outer circumference side of the insertion part, and the uneven surface has an annular groove and an annular projection. The groove has a groove slope that narrows the pipe toward a tip end of the insertion part, and a groove bottom having a constant outer diameter and extending from an insertion-tip-side end of the groove slope to the projection. The sleeve has a small diameter part located on an outer side of the uneven surface in the radial direction to press the hose against the uneven surface.

According to another aspect of the present disclosure, a piping includes: a hose made of an elastic material; a pipe made of metal, the pipe having an insertion part inserted inside of the hose from an end of the hose; and a sleeve arranged on an outer side of the insertion part and the hose in a radial direction to press the hose against the insertion part. The insertion part has an uneven surface around an outer circumference side of the insertion part, and the uneven surface has an annular groove and an annular projection. The groove has a groove slope that narrows the pipe toward a tip end of the insertion part, and a groove bottom that narrows the pipe toward the tip end of the insertion part and that extends from an insertion-tip-side end of the groove slope to the projection. The sleeve has a small diameter part located on an outer side of the uneven surface in the radial direction to press the hose against the uneven surface.

According to another aspect of the present disclosure, a piping includes: a hose made of an elastic material; a pipe made of metal, the pipe having an insertion part inserted inside of the hose from an end of the hose; and a sleeve arranged on an outer side of the insertion part and the hose in a radial direction to press the hose against the insertion part. The insertion part has an uneven surface around an outer circumference side of the insertion part, and the uneven surface having an annular groove and an annular projection. The groove has a groove slope that narrows the pipe toward a tip end of the insertion part, and a groove bottom that thickens the pipe toward the tip end of the insertion part and that extends from an insertion-tip-side end of the groove slope to the projection. The sleeve has a small diameter part located on an outer side of the uneven surface in the radial direction to press the hose against the uneven surface.

Since the groove has the groove bottom between the slope surface and the sealing surface, a space for the hose to be eaten by the groove becomes large. Since the fitting amount of the hose becomes large, the contact area for connecting the hose and the sealing surface becomes large. Since the contact area for connecting the hose and the sealing surface becomes large, even if a tension is applied to the hose, the hose is hardly moved to escape from the sleeve. Thus, the contact area is restricted from decreasing. Accordingly, the sealing nature can be raised for the piping by which the hose made of elastic material and the pipe made of metal are connected with each other.

### BRIEF DESCRIPTION OF DRAWINGS

FIG. 1 is a sectional view illustrating a piping according to a first embodiment.

FIG. 2 is a schematic perspective view illustrating a hose of FIG. 1.

FIG. 3 is a sectional view illustrating a sleeve of FIG. 1.

FIG. 4 is a sectional view illustrating the hose and the sleeve of FIG. 1.

FIG. 5 is a graph illustrating a relation between a length of a groove bottom surface and a hose bite amount in the piping of FIG. 1.

FIG. 6 is a graph comparing airtightness durability between the piping of FIG. 1 and a conventional piping.

FIG. 7 is a sectional view illustrating a first modification of the piping of the first embodiment.

FIG. 8 is a sectional view illustrating a second modification of the piping of the first embodiment.

FIG. 9 is a sectional view illustrating a third modification of the piping of the first embodiment.

FIG. 10 is a sectional view illustrating a sleeve in a fourth modification of the piping of the first embodiment.

FIG. 11 is a sectional view illustrating a sleeve of a piping according to a second embodiment.

FIG. 12 is a sectional view illustrating a sleeve of a piping according to a third embodiment.

### DESCRIPTION OF EMBODIMENTS

Hereinafter, embodiments will be described according to the drawings. Same or equivalent portions among respective embodiments below are labeled with same reference numerals in the drawings, and the explanation may be omitted. When only a part of a configuration is described in an embodiment, another preceding embodiment may be applied to the other parts of the configuration.

### First Embodiment

A first embodiment is described. A piping of this embodiment is used for a refrigerating cycle equipment for a vehicle. Specifically, the piping connects a compressor for an engine of the vehicle to a refrigerating cycle component in the vehicle body to circulate refrigerant.

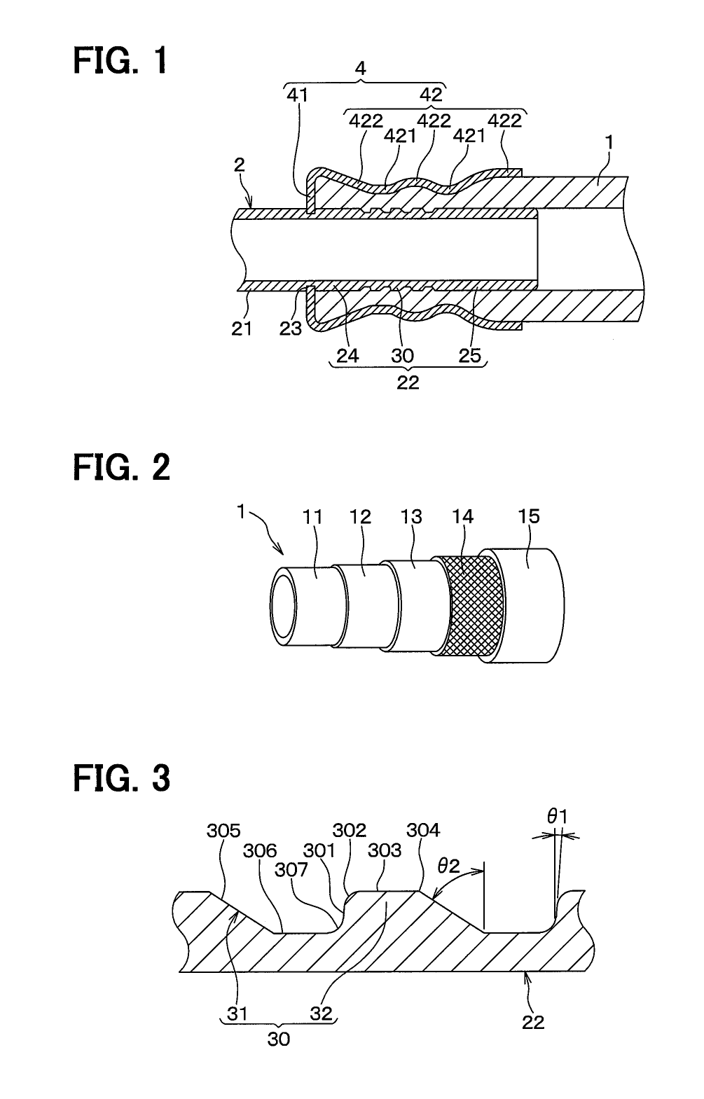

As shown in FIG. 1, FIG. 2, and FIG. 3, the piping includes a hose 1 made of elastic material, a pipe 2 made of metal, and a sleeve 4 made of metal.

The hose 1 has five-layer structure. Specifically, the hose 1 has a cylindrical inner rubber layer 11 made of rubber material such as CR base or EPDM base, at the innermost part of the hose 1. A cylindrical resin layer 12 made of resin material such as nylon base is arranged on the outer circumference side of the inner side rubber layer 11. The resin layer 12 prevents a penetration of refrigerant. A cylindrical middle rubber layer 13 made of rubber material such as CR base or EPDM base is arranged on the outer circumference side of the resin layer 12. A reinforcing fiber layer 14 made of PET base fibers is arranged on the outer circumference side of the middle rubber layer 13. A cylindrical outer rubber layer 15 made of rubber material such as EPDM base is arranged on the outer circumference side of the reinforcing fiber layer 14.

The hose 1 covers the external surface of the pipe 2 with a predetermined length of an end portion of the pipe 2. In other words, the end portion of the pipe 2 having the predetermined length is inserted into the hose 1 from the open end of the hose 1.

The pipe 2 is made of aluminum, copper, or iron. The pipe 2 has a pipe part 21 shaped in a pipe that is the original shape without being processed and exposed to the exterior of the hose 1, and an insertion part 22 inserted inside of the hose 1 from the open end of the hose 1. An annular groove 23 is defined between the pipe part 21 and the insertion part 22, and corresponds to a holding part for fixing the sleeve 4. The groove 23 is formed around the outer circumference side of the pipe 2.

The insertion part 22 has a base cylindrical surface 24, an uneven surface 30, and an end cylindrical surface 25. The end cylindrical surface 25, the uneven surface 30, and the base cylindrical surface 24 are arranged in this order from the tip side of the insertion part 22.

The base cylindrical surface 24 is formed around the outer circumference side of the insertion part 22, and is located between the base side of the insertion part 22 and the uneven surface 30. The base cylindrical surface 24 is positioned adjacent to the groove 23. The base cylindrical surface 24 is located at a position nearest to the pipe part 21, of the insertion part 22. A part of the insertion part 22, in which the base cylindrical surface 24 is defined, is also called as base. The base cylindrical surface 24 is formed to have a predetermined axial length so as to be in contact with the inner circumference side of the hose 1 with a predetermined length. The axial length of the base cylindrical surface 24 is shorter than an axial length of the uneven surface 30.

The uneven surface 30 is formed on the outer circumference side of the insertion part 22, and has plural annular grooves 31 and plural annular projections 32. The groove 31 and the projection 32 are arranged alternately in the axial direction of the insertion part 22. An uneven surface unit is consisted of the one groove 31 and one projection adjacent to each other, and the uneven surface 30 has plural uneven surface units.

The projection 32 is defined by a seal slope 301, a first convex curve 302, a projection outer circumference surface 303, a second convex curve 304, a groove slope 305, and a concave curve 307. The groove 31 is a space defined by the second convex curve 304, the groove slope 305, a groove bottom 306, the concave curve 307, the seal slope 301, and the first convex curve 302. Here, the groove bottom 306 is provided between the seal slope 301 and the groove slope 305 to enlarge the space of the groove 31.

The uneven surface 30 is formed by the seal slope 301, the first convex curve 302, the projection outer circumference surface 303, the second convex curve 304, the groove slope 305, the groove bottom 306, and the concave curve 307, each of which extends annularly.

The seal slope 301 is formed in a boundary part between the insertion-tip-side end of the groove 31 and the projection 32. The seal slope 301 is a surface perpendicular to the axis of the insertion part, or a taper surface in which the pipe becomes thick toward the tip side of the insertion part. Specifically, an angle θ1 defined between a line which intersects perpendicularly to the axis of the insertion part and the seal slope 301 is desirably in a range of 0-30 degrees. In addition, as the angle θ1 is closer to 0 degree, the surface pressure of the contact part between the inner circumference part of the hose 1 and the seal slope 301 becomes higher, such that the seal nature between the hose 1 and the insertion part 22 improves.

The projection outer circumference surface 303 is located next to the seal slope 301 on the tip side of the insertion part, and the outer diameter is fixed. The projection outer circumference surface 303 and the seal slope 301 are connected by the first convex curve 302 that has an arc form in the cross-section perpendicular to the axis of the insertion part. In other words, the boundary part between the projection outer circumference surface 303 and the seal slope 301 has an arc-shaped cross-section.

The groove slope 305 is located next to the projection outer circumference surface 303 on the tip side of the insertion part, and has a taper shape in which the pipe becomes narrow toward the tip side of the insertion part. An angle θ2 defined between the line which intersects perpendicularly to the axis of the insertion part and the groove slope 305 is larger than the angle θ1 of the seal slope 301. More specifically, the angle θ2 of the groove slope 305 is preferably in a range of 43-60 degrees. The groove slope 305 and the projection outer circumference surface 303 are connected by the second convex curve 304 having an arc-shaped cross-section.

The groove bottom 306 has a constant outer diameter, and is extended from the insertion-tip-side end of the groove slope 305 to the projection 32. The groove bottom 306 and the seal slope 301 are connected by the concave curve 307 that is a boundary part having an arc-shaped cross-section.

The end cylindrical surface 25 is formed around the outer circumference side of the insertion part 22, and is located between the uneven surface 30 and the tip end of the insertion part. The end cylindrical surface 25 is defined within the area near the tip end of the insertion part. The end cylindrical surface 25 is formed to have a predetermined axial length to be in contact with the inner circumference side of the hose 1 with a predetermined length. The axial length of the end cylindrical surface 25 is shorter than an axial length of the uneven surface 30.

The sleeve 4 is a pipe component made of metal such as aluminum, copper, or iron. The sleeve 4 is arranged on the radially outer side of the insertion part 22 and the end of the hose 1. The sleeve 4 is a component which presses the hose 1 against the insertion part 22. The hose 1, the pipe 2, and the sleeve 4 are arranged to overlap with each other in the radial direction.

The sleeve 4 has a disk part 41 and a cylinder part 42. The disk part 41 is a disc plate portion which spreads in the radial direction of the pipe 2. The radially inner periphery of the disk part 41 is loosely fitted into the groove 23. Thereby, the sleeve 4 is supported on the pipe 2. The sleeve 4 is supported by the pipe 2 in the axial direction and the radial direction.

One end of the cylinder part 42 is connected to the disk part 41. The other end of the cylinder part 42 forms a circular open end. The hose 1 is inserted into the cylinder part 42. In other words, the cylinder part 42 is arranged to cover the radially outer side of the hose 1.

The cylinder part 42 has plural annular small diameter parts 421 and plural annular large diameter parts 422. In detail, the cylinder part 42 has two small diameter parts 421 and three large diameter parts 422. The small diameter part 421 and the large diameter part 422 are arranged alternately in the axial direction. The outer diameter of the small diameter part 421 is smaller than the outer diameter of the large diameter part 422. The inside diameter of the small diameter part 421 is smaller than the inside diameter of the large diameter part 422. The inside diameter of the small diameter part 421 is smaller than the outer diameter of a non-deforming part of the hose 1.

The small diameter part 421 is formed by plastically deforming the cylinder part 42, after arranging the hose 1, the pipe 2, and the sleeve 4 to overlap with each other in the radial direction. The hose 1 is deformed and pressed against the uneven surface 30 by forming the small diameter part 421.

In addition, in this embodiment, of the two small diameter parts 421, one small diameter 421 and the groove 31 overlap with each other in the radial direction.

Moreover, the number of the uneven surface units of the uneven surface 30 of the pipe 2 is larger than the number of the small diameter parts 421. At least one of the uneven surface units is located at the radially inner side of the small diameter part 421.

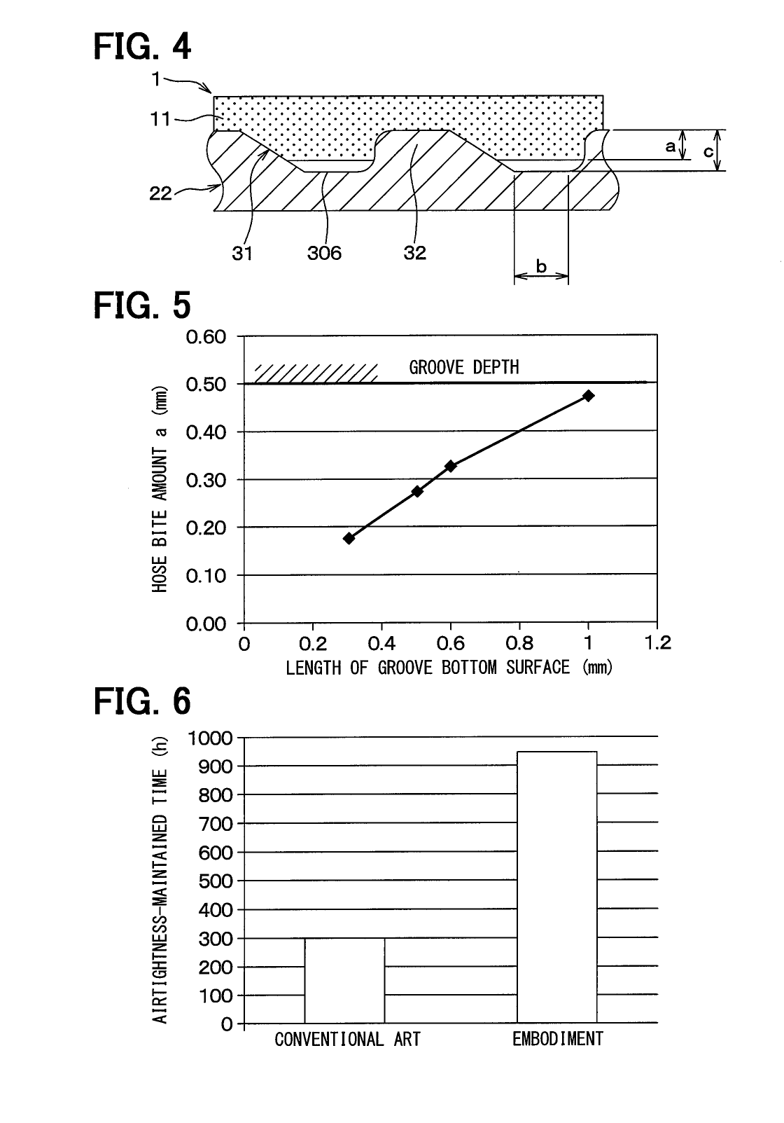

As shown in FIG. 4, a portion of the hose 1 deformed by the small diameter part 421 is bitten by the groove 31. Hereafter, “a hose bite part” represents a part of the hose 1 which is fitted into the groove 31, and “a hose bite amount a” represents a radial dimension of the hose bite part in the radial direction of the hose. Moreover, “a groove bottom length b” represents a length of the groove bottom 306 in the axial direction of the insertion part, and “a groove depth c” represents a depth of the groove 31 in the radial direction of the insertion part.

FIG. 5 illustrates a relation between the hose bite amount “a” and the groove bottom length “b” in the piping in which the groove depth “c” is set as 0.5 mm. By forming the groove bottom 306 like this embodiment, the space of the groove 31 becomes large. Since the hose 1 can easily enter into the groove 31, the hose bite amount “a” is increased as the groove bottom length “b” is increased. Specifically, when the groove bottom length “b” is set as 1 mm, the hose bite amount “a” becomes 0.5 mm which is the maximum of the groove depth “c”. In addition, it is desirable to make the groove bottom length “b” to be larger than the groove depth “c”.

Thus, the connection area of the contact part between the hose 1 and the seal slope 301 becomes large due to the increase in the hose bite amount “a”. Because the connection area of the contact part between the hose 1 and the seal slope 301 becomes large, the hose 1 becomes difficult to move in a direction escaping from the pipe 2 and the sleeve 4, even while a tension is applied to the hose 1. Therefore, the connection area of the contact part is restricted from decreasing. Accordingly, the seal nature between the hose 1 and the insertion part 22 improves.

Moreover, the hose bite part is forced on the groove slope 305, and a component of the force forces the hose bite part onto the seal slope 301 and the first convex curve 302. Therefore, the surface pressure of the contact part between the inner circumference part of the hose 1, and the seal slope 301 and the first convex curve 302 becomes high, such that the seal nature between the hose 1 and the insertion part 22 improves.

Here, the piping of this embodiment equipped with the groove bottom 306 and a conventional piping which is not equipped with the groove bottom 306 are prepared, and the airtightness durability is evaluated. In the piping of this embodiment, the groove bottom length “b” is 0.7 mm, and the hose bite amount “a” is 0.35 mm. In the conventional piping, the groove bottom length “b” is 0 mm, and the hose bite amount “a” is less than or equal to 0.17 mm.

In the evaluation test, the piping is heated at 14020 C., and a pressure of 3.53 MPa is impressed into the piping for every predetermined time. Then, the existence of the leak is measured.

FIG. 6 illustrates the evaluation results, in which the vertical axis represents a time period before a leak occurs, i.e., airtightness-maintained time.

As a result of the evaluation test, when 300 hours pass in the conventional piping, a leak is occurred between the hose 1 and the insertion part 22.

According to the piping of this embodiment, when 900 hours pass, a crack is generated in the hose 1 and a leak is generated from the crack part. In other words, a leak is not generated between the hose 1 and the insertion parts 22 until at least 900 hours pass in the piping of this embodiment. The airtightness durability of the hose 1 and the insertion part 22 improves, compared with the conventional piping.

As explained above, according to this embodiment, the hose bite amount “a” is increased by forming the groove bottom 306, such that the seal nature between the hose 1 and the insertion part 22 can be raised.

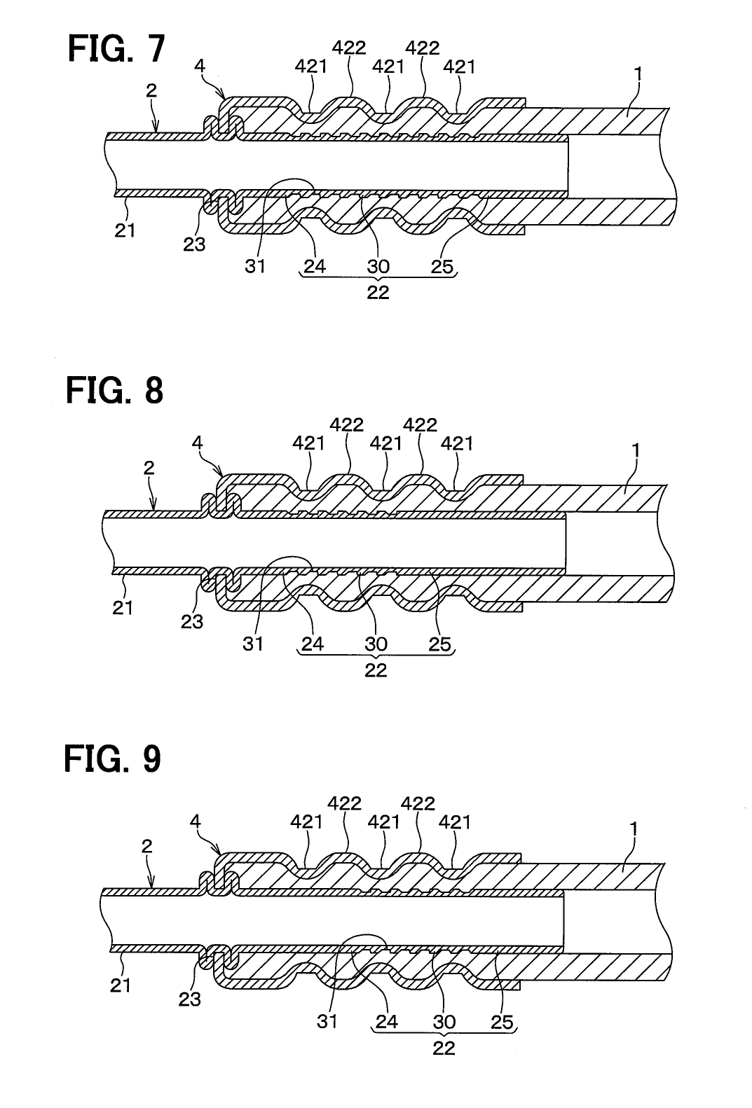

In this embodiment, two small diameter parts 421 are formed, and one of the small diameter parts 421 overlaps with the groove 31 in the radial direction. In a first modification shown in FIG. 7, three small diameter parts 421 are formed, and the three small diameter parts 421 may overlap with the groove 31 in the radial direction. In this case, the seal nature between the hose 1 and the insertion part 22 can be raised, and the strength of the hose 1 against the detachment can be improved.

In a second modification shown in FIG. 8, three small diameter parts 421 are formed, and two of the small diameter parts 421 which are located far from the tip end of the insertion part 22 overlap with the groove 31 in the radial direction.

In a third modification shown in FIG. 9, three small diameter parts 421 are formed, and two of the small diameter parts 421 which are located near the tip end of the insertion part 22 overlap with the groove 31 in the radial direction.

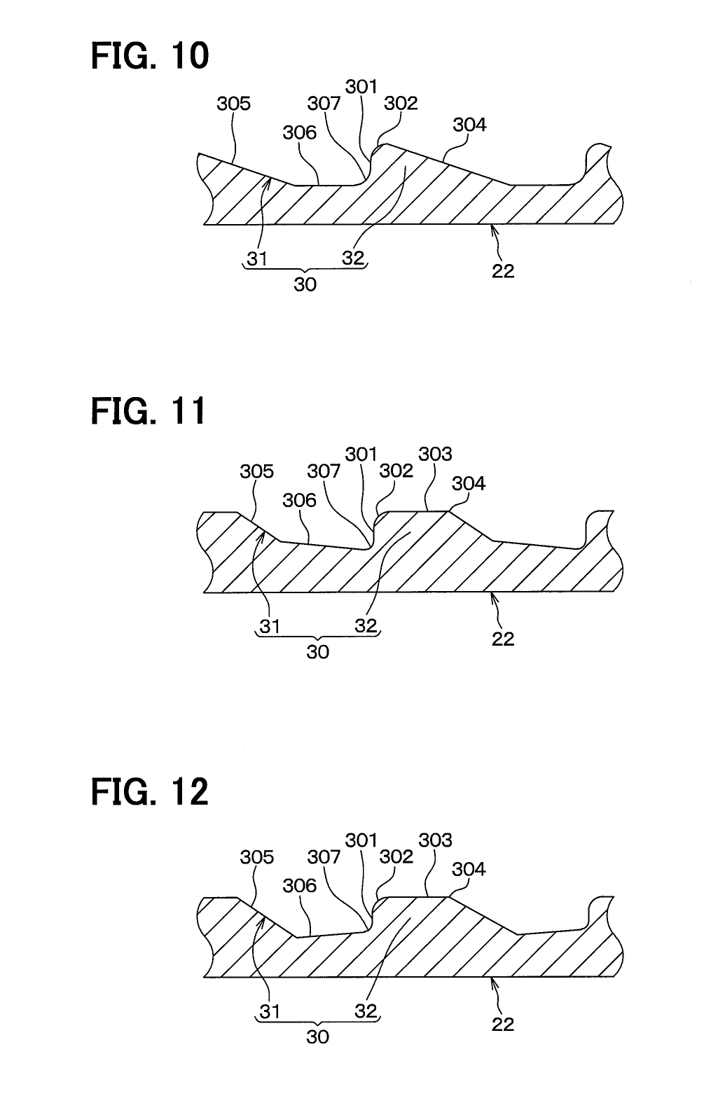

In a fourth modification shown in FIG. 10, the uneven surface 30 may have no projection outer circumference surface 303. In this case, the insertion part 22 can be shortened.

In the embodiment, the groove slope 305 has the taper shape. That is, the groove slope 305 has a straight line shape in the cross-section perpendicular to the axis of the insertion part. Alternatively, the groove slope 305 may have a curved form in the cross-section perpendicular to the axis of the insertion part.

### Second Embodiment

A second embodiment is described with reference to FIG. 11. The explanation of portions the same or equal portions as the first embodiment is omitted or simplified in this embodiment.

In this embodiment, as shown in FIG. 11, the groove bottom 306 is a surface having a taper shape in which the pipe becomes narrow toward the tip side of the insertion part. In detail, the taper angle of the groove bottom 306 is set smaller than the taper angle of the groove slope 305.

Since the space of the groove 31 becomes large also in this case, the same effect is acquired as the first embodiment.

In this embodiment, the groove bottom 306 has the taper shape. That is, the groove bottom 306 has a straight line shape in the cross-section perpendicular to the axis of the insertion part. Alternatively, the groove bottom 306 may have a curved form in the cross-section perpendicular to the axis of the insertion part.

### Third Embodiment

A third embodiment is described with reference to FIG. 12. The explanation of portions the same or equal portions as the first embodiment is omitted or simplified in this embodiment.

In this embodiment, as shown in FIG. 12, the groove bottom 306 is a surface having a taper shape in which the pipe becomes thick toward the tip side of the insertion part. The taper angle of the groove bottom 306 is set smaller than the taper angle of the groove slope 305.

Since the space of the groove 31 becomes large also in this case, the same effect is acquired as the first embodiment.

In this embodiment, the groove bottom 306 has the taper shape. That is, the groove bottom 306 has a straight line shape in the cross-section perpendicular to the axis of the insertion part. Alternatively, the groove bottom 306 may have a curved form in the cross-section perpendicular to the axis of the insertion part.

### Other Embodiment

The piping of the present disclosure is used for the refrigerating cycle equipment for a vehicle in the above embodiments, but the present disclosure is applicable also to a piping for other uses.

The hose 1 having the resin layer 12 is used in the embodiment, but the hose 1 which is not equipped with the resin layer 12 can be used when there is no concern about a penetration of fluid.

It should be appreciated that the present disclosure is not limited to the embodiments described above and can be modified appropriately.

The embodiments above are not irrelevant to one another and can be combined appropriately unless a combination is obviously impossible.

In the respective embodiments above, it goes without saying that elements forming the embodiments are not necessarily essential unless specified as being essential or deemed as being apparently essential in principle.

In a case where a reference is made to the components of the respective embodiments as to numerical values, such as the number, values, amounts, and ranges, the components are not limited to the numerical values unless specified as being essential or deemed as being apparently essential in principle.

Also, in a case where a reference is made to the components of the respective embodiments above as to shapes and positional relations, the components are not limited to the shapes and the positional relations unless explicitly specified or limited to particular shapes and positional relations in principle.

### CONCLUSION

According to a first viewpoint represented by a part of the above-mentioned embodiment, the insertion part of the pipe has the uneven surface around the outer circumference side of the insertion part, and the uneven surface has the annular groove and the annular projection. The groove has the groove slope that narrows the pipe toward a tip end of the insertion part, and the groove bottom having a constant outer diameter and extending from an insertion-tip-side end of the groove slope to the projection. The sleeve that presses the hose against the insertion part has a small diameter part located on an outer side of the uneven surface in the radial direction to press the hose against the uneven surface.

Moreover, according to a second viewpoint, the insertion part of the pipe has the uneven surface around the outer circumference side of the insertion part, and the uneven surface has the annular groove and the annular projection. The groove has the groove slope that narrows the pipe toward a tip end of the insertion part, and the groove bottom that narrows the pipe toward the tip end of the insertion part and that extends from an insertion-tip-side end of the groove slope to the projection. The sleeve that presses the hose against the insertion part has a small diameter part located on an outer side of the uneven surface in the radial direction to press the hose against the uneven surface.

Moreover, according to a third viewpoint, the insertion part of the pipe has the uneven surface around the outer circumference side of the insertion part, and the uneven surface has the annular groove and the annular projection. The groove has the groove slope that narrows the pipe toward a tip end of the insertion part, and the groove bottom that thickens the pipe toward the tip end of the insertion part and that extends from an insertion-tip-side end of the groove slope to the projection. The sleeve that presses the hose against the insertion part has a small diameter part located on an outer side of the uneven surface in the radial direction to press the hose against the uneven surface.

Moreover, according to a fourth viewpoint, the uneven surface is one of a plurality of uneven surface units. The uneven surface unit is consist of one groove and one projection. At least one of the plurality of uneven surface units is located on an inner side of the small diameter part in the radial direction.

Moreover, according to a fifth viewpoint, the small diameter part of the sleeve is one of a plurality of small diameter parts, and the number of the uneven surface units is larger than the number of the small diameter parts.

Moreover, according to a sixth viewpoint, the uneven surface has a seal slope formed in a boundary part between an insertion-tip-side end of the groove and the projection. An angle defined between the groove slope and a line perpendicular to an axis of the insertion part is larger than an angle defined between the seal slope and the line perpendicular to the axis of the insertion part.

Moreover, according to a seventh viewpoint, a boundary part defined between an outer circumference side of the projection and the seal slope has an arc-shaped cross-section.

Moreover, according to an eighth viewpoint, a length of the groove bottom in an axial direction of the insertion part is larger than a depth of the groove in a radial direction of the insertion part.

What is claimed is:

1. A piping comprising:
a hose made of an elastic material;
a pipe made of metal, the pipe having an insertion part inserted inside of the hose from an end of the hose; and
a sleeve arranged on an outer side of the insertion part and the hose in a radial direction to press the hose against the insertion part, wherein
the insertion part has an uneven surface around an outer circumference side of the insertion part, the uneven surface having an annular groove and an annular projection,
the groove has a groove slope that narrows the pipe toward a tip end of the insertion part, and a groove bottom having a constant outer diameter and extending from an insertion-tip-side end of the groove slope to the projection, and
the sleeve has a small diameter part located on an outer side of the uneven surface in the radial direction to press the hose against the uneven surface.

2. A piping comprising:
a hose made of an elastic material;
a pipe made of metal, the pipe having an insertion part inserted inside of the hose from an end of the hose; and
a sleeve arranged on an outer side of the insertion part and the hose in a radial direction to press the hose against the insertion part, wherein
the insertion part has an uneven surface around an outer circumference side of the insertion part, the uneven surface having an annular groove and an annular projection,
the groove has a groove slope that narrows the pipe toward a tip end of the insertion part, and a groove bottom that narrows the pipe toward the tip end of the insertion part and that extends from an insertion-tip-side end of the groove slope to the projection, and
the sleeve has a small diameter part located on an outer side of the uneven surface in the radial direction to press the hose against the uneven surface.

3. A piping comprising:
a hose made of an elastic material;
a pipe made of metal, the pipe having an insertion part inserted inside of the hose from an end of the hose; and
a sleeve arranged on an outer side of the insertion part and the hose in a radial direction to press the hose against the insertion part, wherein
the insertion part has an uneven surface around an outer circumference side of the insertion part, the uneven surface having an annular groove and an annular projection,
the groove has a groove slope that narrows the pipe toward a tip end of the insertion part, and a groove bottom that thickens the pipe toward the tip end of the insertion part and that extends from an insertion-tip-side end of the groove slope to the projection, and
the sleeve has a small diameter part located on an outer side of the uneven surface in the radial direction to press the hose against the uneven surface.

4. The piping according to claim 1, wherein
the uneven surface is one of a plurality of uneven surface units, the uneven surface unit being consist of one groove and one projection, and
at least one of the plurality of uneven surface units is located on an inner side of the small diameter part in the radial direction.

5. The piping according to claim 4, wherein
the small diameter part of the sleeve is one of a plurality of small diameter parts, and
the number of the uneven surface units is larger than the number of the small diameter parts.

6. The piping according to claim 1, wherein
the uneven surface has a seal slope formed in a boundary part between an insertion-tip-side end of the groove and the projection, and
an angle defined between the groove slope and a line perpendicular to an axis of the insertion part is larger than an angle defined between the seal slope and the line perpendicular to the axis of the insertion part.

7. The piping according to claim 6, wherein
a boundary part defined between an outer circumference side of the projection and the seal slope has an arc-shaped cross-section.

8. The piping according to claim 1, wherein
a length of the groove bottom in an axial direction of the insertion part is larger than a depth of the groove in a radial direction of the insertion part.
